(19) United States
(12) Patent Application Publication
(10) Pub. No.: US 2009/0013257 A1
(43) Pub. Date: Jan. 8, 2009

(54) Network device with display unit

(75) Inventor: Ah-Jee Wang, Taipei City (TW)

Correspondence Address: BACON & THOMAS, PLLC, 625 SLATERS LANE, FOURTH FLOOR, ALEXANDRIA, VA, 22314-1176, US

(73) Assignee: D-Link Corporation, Taipei City (TW)

(21) Appl. No.: 11/878,365

(22) Filed: Jul. 24, 2007

(30) Foreign Application Priority Data
Jul. 5, 2007 (TW) 096210933

(51) Int. Cl. G06F 15/177

(52) U.S. Cl. 715/736

(57) ABSTRACT

In a network device with a display unit, a protruding portion is protruded from a top surface of the main body of the network device, a slanting surface disposed on a side of the protruding portion and proximate to the main body, a display unit installed in the protruding portion, a display screen disposed on a side of the display unit and exposed from the slanting surface, a connecting portion disposed on a side of the main body for exchanging network signals, and a press key portion disposed on the main body and at a position proximate to the display unit. When the network device is turned on, the display screen exposed from the slanting surface of the display unit allows user to learn about the status of the network device and the status of a network connection and set up the network device by operating the press key portion.

### FIELD OF THE INVENTION

The present invention relates to a network device, and more particularly to a network device with a display unit.

### BACKGROUND OF THE INVENTION

As science and technology advance, network merges rapidly into every area of our life, and computer network reduces the distance between people and promotes the communications and idea exchanges with two parties. Network has brought tremendous convenience to our work and life, and people have more chances of using wireless network devices now. Thus, network device manufacturers keep on developing all kinds of multifunctional network devices to cope with market requirements and satisfy user's needs, and wireless network devices have become an indispensable tool to the life and work of many people.

Referring to FIG. 1 for a prior art network device (such as a router), the network device includes a casing 1 and at least one light emitting element 2 (such as LED), and a lateral side of the casing 1 has at least one network port 3, and each network port 3 is provided for connecting network equipments and components (such as a bridge or a server), and each light emitting element 2 is installed in the casing 1 and exposed from another lateral side of the casing 1 for user's view, wherein the light emitting element 2 is used for representing a color (such as red, blue and green), or for representing a displayed information of a status of the network device corresponding to the position of the text printed on the casing 1, and the light emitting elements 2 and the network ports 3 are connected in the casing 1, such that if the network device detects a different connection of network equipments and components, the corresponding light emitting element 2 will receive a signal, and the light emitting element 2 will start emitting light or blinking according to the signal. On the other hand, when the network device detects that one of the network equipments and components cannot be connected, another corresponding light emitting element 2 starts changing its color or goes off according to the signal. Therefore, users can perform corresponding actions according to the information indicated by the light emitting element 2.

However, the representation of the displayed information of the network device still has the following two drawbacks:

1. Since the color of a light source of each light emitting element 2 represents a different meaning, a general user usually confuses or cannot sense the connection status of a network device when the network device is connected, and users cannot know about the status of the network device, and such arrangement results in a misjudgment easily.

2. Since the Wi-Fi authentication organization has introduced a Wi-Fi protected setup (WPS) security authentication mechanism, the displayed information of a network device becomes insufficient; particularly for the connection of a network device with the Internet involves a connection protocol and an authentication, users cannot have sufficient information on the status of error detection or setup simply by using the light signals to indicate the status of a succeeded or failed connection.

Therefore, finding a way of overcoming the shortcomings of the prior art while maintaining the advantages of the network device is an object that the inventor of the present invention attempted to do.

### SUMMARY OF THE INVENTION

It is a primary objective of the present invention to provide a network device with a display unit, wherein a protruding portion is protruded from a top surface of the main body of a network device, a slanting surface disposed on a side of the protruding portion and proximate to the main body, a display unit installed in the protruding portion, a display screen disposed on a side of the display unit and exposed from the slanting surface, a connecting portion disposed on a side of the main body for exchanging network signals, a press key portion disposed on the main body and proximate to the display unit, such that when the network device is turned on, the display screen exposed from the slanting surface of the display unit allows user to learn about the status of the network device and the status of a network connection and set up the network device by operating the press key portion.

To make it easier for our examiner to understand the objective, technical characteristics and effects of the present invention, preferred embodiments will be described with accompanying drawings as follows;

### BRIEF DESCRIPTION OF THE DRAWINGS

FIG. 1 is a perspective view of a prior art network device;

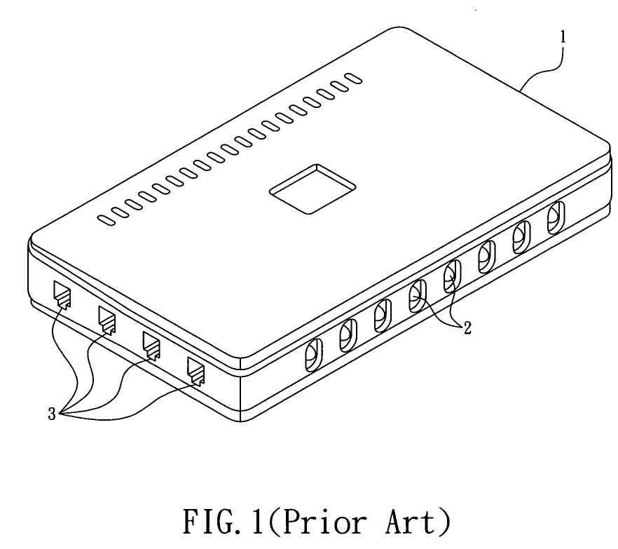

FIG. 2 is a perspective view of the present invention; and

FIG. 3 is another perspective view of the present invention.

### DETAILED DESCRIPTION OF THE PREFERRED EMBODIMENTS

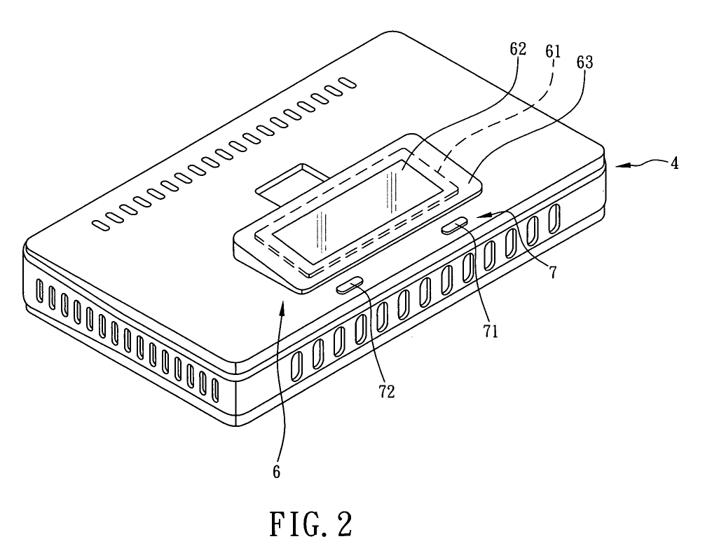

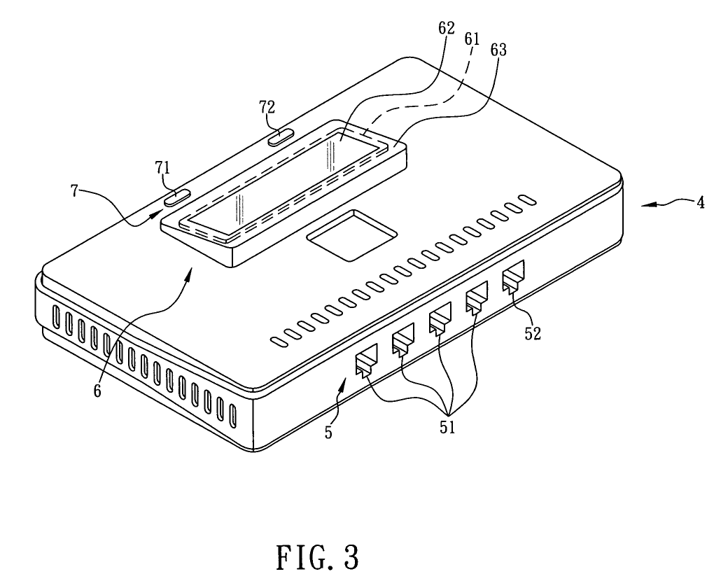

Referring to FIGS. 2 and 3 for a network device with a display unit in accordance with a preferred embodiment of the present invention, the network device comprises a main body 4, a connecting portion 5 disposed on a side of the main body 4 for exchanging network signals, a protruding portion 6 protruded from the top surface of the main body 4, a slanting surface 63 disposed on a side of the protruding portion 6 and proximate to the main body 4 and having a display unit 61 such as an organic light emitting display (OLED), a display screen 62 disposed on a side of the display unit 61 and exposed from the slanting surface 63, a press key portion 7 disposed on the main body 4 and proximate to the display unit 61 for setting the information of the network device, and having a configuration key 71 and a wakeup key 72, such that when the network device is turned on, the display screen 62 exposed on the slanting surface 63 of the display unit 61 allows users to learn about the status of the network device and the status of the network connection, and set the network device by operating the press key portion 7.

The wakeup key 72 is provided for exiting a sleep mode of the network device. The display unit 61 at a sleep mode is at a power-saving mode for saving the power of the network device. If the display unit 61 is turned on by pressing the wakeup key 72, the wakeup key 72 will send a signal to the display unit 61, and the signal will trigger and wake up the display unit 61 after the display unit 61 has received the signal.

The configuration key 71 is used for setting a specific status of the network device, such as setting a communication protocol (including TCP, UDP and ICMP), a connection type and a time setting. If the configuration key 71 is pressed to selectively set a required execution mode, a control signal of the configuration key 71 will be sent to the display unit 61. After the display unit 61 receives a signal transmitted according to the control signal, the received signal is converted into a text or a graphic or an output of both text and graphic. Therefore, users can set the required functions as needed, and the invention also allows users to view the information and save power of the network device.

The connecting portion 5 includes a plurality of internal network ports 51 (LAN ports) and an external network port 52 (WAN port), and the external network port 52 is disposed on the main body 4 and adjacent to one of the lateral sides of the display unit 61 for connecting an external network connecting equipment (such as a xDSL/cable modem) and exchanging network signals with the outside, and the internal network ports 51 are disposed on the main body 4 and at a position adjacent to the external network port 52 for connecting a connecting device (such as a desktop computer, a notebook computer or a personal digital assistant) with an internal network equipment, and the internal network ports 51 are provided for transmitting and receiving the information of the internal network equipment. When the external network port 52 and the internal network ports 51 are connected by the external network connecting equipment or the connecting device, the external network port 52 and the internal network ports 51 send data signals to the display unit 61, and the display unit 61 converts the data signals into texts and graphics, so that users can view the current status of the network device and the status of connecting the network cable through the display unit 61, and users can also know about the information of the processing status of the network device.

While the invention has been described by means of specific embodiments, numerous modifications and variations could be made thereto by those skilled in the art without departing from the scope and spirit of the invention set forth in the claims.

What is claimed is:

1. A network device with a display unit, comprising:
a main body;
a connecting portion, disposed on a side of the main body, for exchanging network signals;
a protruding portion, disposed on a top surface of the main body, and having
a slanting surface on a side of the protruding portion;
a display unit, installed in the protruding portion, and having a display screen disposed on a side of the display unit and exposed from the slanting surface of the display unit; and
a press key portion, disposed on the display unit and proximate to the main body, for setting the information of the network device.

2. The network device as recited in claim 1, wherein the press key portion comprises:
a configuration key, for setting the status of the network device when the configuration key is triggered; and
a wakeup key, for exiting a sleep mode of the network device when the wakeup key is triggered.

3. The network device as recited in claim 2, wherein the connecting portion comprises:
an external network port, coupled to an external network equipment, for exchanging network signals with the outside; and
a plurality of internal network ports, respectively coupled to an internal network equipment, for transmitting the information of the internal network equipment.
